(19) United States
(12) Patent Application Publication
(10) Pub. No.: US 2012/0199110 A1
(43) Pub. Date: Aug. 9, 2012

(54) HUMIDITY CONTROL SYSTEM FOR USE WITH A WARMING APPLIANCE AND METHOD FOR ASSEMBLING THE SAME

(76) Inventors: Timothy Scott SHAFFER, Louisville, KY (US); Ravi Ayyalasomayajula, Hyderabad (IN); Rajendra Prasad Gottipati, Hyderabad (IN)

(21) Appl. No.: 13/022,426

(22) Filed: Feb. 7, 2011

(51) Int. Cl. A21B 1/00; B23P 11/00; F24F 3/14

(52) U.S. Cl. 126/19 R; 236/44 A; 126/1 R; 29/428

(57) ABSTRACT

A humidity control system for use with a warming appliance including a warming cavity includes an internal reservoir for retaining water within the warming cavity, a metering device, and a water source external to the warming cavity and coupled in flow communication with the internal reservoir via the metering device. A controller is communicatively coupled to the metering device. The controller is configured to control a flow rate of the water from the water source to the internal reservoir based on a selected food type being warmed within the warming cavity.

### BACKGROUND OF THE INVENTION

The embodiments described herein relate generally to warming appliances and, more particularly, to a humidity control system for use with warming appliances.

After cooking food, foods removed from a heat source generally cool below a satisfactory temperature. As such, at least some known warming appliances are configured to maintain a temperature of the cooked food at a level to keep the food warm, without further cooking the food. As used herein, the term “warming appliance” refers to any appliance that maintains a temperature of an item without cooking the item. For example, a warming appliance can be a warming drawer and/or an oven. In at least one known conventional baking oven, the oven cooks the food and also has a “warming” or “holding” function where the food is maintained at a safe sanitary temperature without necessarily continuing to cook the food. However, the quality of the cooked food tends to deteriorate due to loss of humidity during prolonged exposure to warming temperatures.

A relationship between relative humidity and air temperatures is known in the field of psychrometrics, which refers to the properties of moist air. Relative humidity is a measure of actual moisture present in the air compared to a maximum amount of moisture in the air at a given temperature. Certain food types have both a certain safe sanitary temperature to avoid unsafe microbiological activity and a desired state of relative humidity to maintain food texture at an optimum level for eating. Known warming appliances use one of two known means of measuring relative humidity—direct sensing humidity sensors or wet bulb/dry bulb temperature measurements mapped onto a psychrometric chart.

At least some known warming appliances use a large amount of water, such as between about a gallon and about three gallons, to provide humidity within the cavity of the warming device. More specifically, the water is contained within a large reservoir and evaporates from the reservoir into the cavity when the cavity is heated. Because the large reservoir is positioned adjacent the cavity, all of the water within the reservoir must be heated during each use of the warming appliance. In many cases, a relative humidity level is not controlled, but rather an arbitrary amount of moisture is added regardless of food type. Such systems do not include a reservoir heater that is independent of oven heaters. Rather, the water is merely allowed to evaporate from the large reservoir, and the relative humidity within the cavity cannot be controlled.

At least some other known warming appliances include a reservoir of water with a dedicated heater. In such warming appliances the reservoir temperature is controlled to approximate a wet bulb temperature for the oven cavity. To maintain the humidity in the cavity either directly or indirectly, complicated wet bulb and dry bulb temperature methods are used in such warming appliances. To maintain the humidity in the cavity of such known warming appliances, complicated wet bulb and dry bulb temperature methods are used. More specifically, the internal reservoir is heated independent of the oven cavity to a desired “wet bulb” temperature, while the air within the warming cavity is heated to a desired “dry bulb” temperature. The water temperature is regulated to reach a wet bulb temperature that corresponds with a user selected level of relative humidity. This approach maintains the user selected humidity levels, but is extremely sluggish due to the large size of the water reservoir and the extra thermal capacitance of the reservoir and its associated heater hardware. Further, when using such warming appliances, the user selects a level of relative humidity and, thus, should have knowledge of proper relative humidity levels for each type of food.

At least another known warming appliance uses a humidity sensor and a large reservoir of water within the warming chamber. The humidity sensor provides a signal to a warming oven controller that the controller uses to control cycling of a reservoir heater such the desired relative humidity is reached. However, there are a limited number of humidity sensors capable of handling the range of oven temperatures and such sensors may have unreliable accuracy.

Further, the large amount of water requires a large amount of space in the warming appliance and the water can become fouled during use of the warming appliance. More specifically, the water can become fouled by food residues created during use of the warming appliance. When the water becomes fouled, a user must empty the reservoir and refill the reservoir, which can be difficult and time-consuming. Further, if fouled water continues to be used within the warming appliance, the warming appliance may require cleaning and/or maintenance.

At least one other known warming appliance is a steam baking appliance that uses an external vaporizer or steam generator which is supplied with water. The steam baking appliance heats the water to a boiling level and then directs steam into the baking chamber. However, the supply of steam into the baking chamber typically results in a saturated environment that does not maintain cooked food in a desirable state, but rather in an over-moist state.

### BRIEF SUMMARY OF THE INVENTION

In one aspect, a humidity control system for use with a warming appliance including a warming cavity is provided. The humidity control system includes an internal reservoir for retaining water within the warming cavity, a metering device, and a water source external to the warming cavity and coupled in flow communication with the internal reservoir via the metering device. A controller is communicatively coupled to the metering device. The controller is configured to control a flow rate of the water from the water source to the internal reservoir based on a selected food type being warmed within the warming cavity.

In another aspect, a warming appliance is provided. The warming appliance includes walls at least partially defining a warming cavity for containing an item to be warmed, and a humidity control system. The humidity control system includes an internal reservoir configured to retain water within the warming cavity, a metering device, and a water source external to the warming cavity. The water source is coupled in flow communication with the internal reservoir via the metering device. A controller is communicatively coupled to the metering device. The controller is configured to control a flow rate of the water from the water source to the internal reservoir based on a selected food type to be warmed within the warming cavity.

In yet another aspect, a method for assembling a warming appliance including a cavity having at least one heater is provided. The method includes defining an internal reservoir within the cavity, coupling a water source external to the cavity in flow communication with the internal reservoir, and coupling a metering device in flow communication with the internal reservoir and the water source. A controller is communicatively coupled to the metering device and the at least one heater. The controller is configured to control a flow rate of water from the water source to the internal reservoir via the metering device, wherein the flow rate is based on a selected food type to be warmed within the cavity.

### BRIEF DESCRIPTION OF THE DRAWINGS

FIGS. 1-4 show exemplary embodiments of the systems and method described herein.

FIG. 1 is a schematic view of an exemplary warming appliance.

FIG. 2 is a flow chart showing an exemplary method for assembling the warming appliance shown in FIG. 1.

FIG. 3 is a graph illustrating relative humidity with respect to a flow rate when a cavity is at an average temperature of 140° F.

FIG. 4 is a graph illustrating a percentage of time that a heater is activated with respect to an average flow rate of water into an internal reservoir.

### DETAILED DESCRIPTION OF THE INVENTION

The embodiments described herein provide a warming appliance having a humidity control system that enables a relative humidity within a cavity of the warming appliance to be maintained at a selected level. More specifically, a controller associated with the warming appliance determines a humidity level that is based on, and in response to, an input that indicates or selects a type of item being warmed within the cavity. For example, the user selects a type of food, and the warming appliance determines a humidity range based on what type of food is to be kept warm. In the exemplary embodiment, the user selects different humidity levels by selecting crisp foods, meats, breads, and steamed foods. A metering device external to the cavity controls a supply of water from an external tank into an internal reservoir. The water then evaporates from the internal reservoir into the cavity. In one embodiment, a dedicated heating system is used to heat the water within the internal reservoir to a set temperature. The flow rate of water into the internal reservoir and temperature within the cavity are used to maintain the desired humidity and holding temperature levels. More specifically, the embodiments described herein tune a rate of water being evaporated for a given cavity size as a function of cavity temperature to achieve a desired humidity in the cavity, without directly or indirectly measuring the humidity in the cavity.

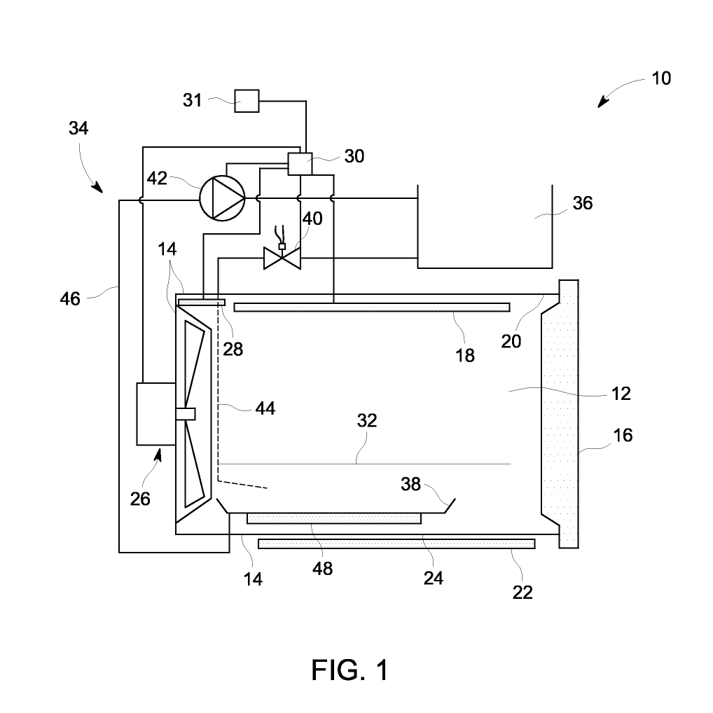

FIG. 1 is a schematic view of an exemplary warming appliance 10. In the exemplary embodiment, warming appliance 10 is an oven and/or a warming drawer. Warming appliance 10 includes a cavity 12 defined by walls 14 and a door 16. In one embodiment, walls 14 are surrounded by a cabinet (not shown). Door 16 is movable with respect to walls 14 to access cavity 12 in an open position and to seal cavity 12 in a closed position. Alternatively, when warming appliance 10 is a warming drawer, door 16 is fixed to walls 14, and walls 14 are movable with respect to the cabinet to allow a user to pull on door 16 to slide walls 14 from the cabinet. In the exemplary embodiment, a broil heater 18 is positioned at a top wall 20 of cavity 12, and a bake heater 22 is located with respect to a bottom wall 24 of cavity 12. When warming appliance 10 is a warming drawer, broil heater 18 may be omitted. In an alternative embodiment, warming appliance 10 includes a rear heater (not shown). In the exemplary embodiment, warming appliance 10 further includes a fan assembly 26 and a temperature sensor 28. Fan assembly 26 and/or temperature sensor 28 are communicatively coupled to a controller 30. Controller 30 is configured to maintain a temperature and/or humidity within cavity 12, as described in more detail herein. In the exemplary embodiment, controller 30 receives temperature data from temperature sensor 28 to control a temperature and/or a humidity within cavity 12. Further, a user interface 31 enables the user to input data into controller 30. An item to be warmed is supported within cavity 12 on a support or rack 32. Rack 32 is removable from, and/or adjustable within, cavity 12.

In the exemplary embodiment, warming appliance 10 includes a humidity control system 34 that includes an external tank 36, an internal reservoir 38, a metering device 40, and a pump 42. External tank 36 has a capacity of between about 236.6 milliliters (mL) (8 ounces (oz)) and about 1.9 liters (L) (64 oz), and internal reservoir 38 has a capacity of between about 5 mL and about 473.2 mL (16 oz). More specifically, in one embodiment, internal reservoir 38 has a capacity of between about 8.8 mL (0.3 oz) and about 88.7 mL (3 oz) and, more particularly, between about 10 mL (0.3 oz) and about 100 mL (3.4 oz). In a particular embodiment, external tank 36 usually contains about 0.9 L (32 oz), and internal reservoir 38 contains about 29.6 mL (1 oz) during a humidity control operation of warming appliance 10; however, it should be understood that external tank 36 and/or internal reservoir 38 can each include any suitable amount of water for use during operation of warming appliance 10. In the exemplary embodiment, internal reservoir 38 is coupled above bottom wall 24; however, internal reservoir 38 can be integrated into bottom wall 24. For example, in an alternate embodiment, water is channeled into cavity 12 onto bottom wall 24, and bottom wall 24 acts as internal reservoir 38. External tank 36 is an example of a water source external to cavity 12 and coupled in flow communication with internal reservoir 38; however, any suitable water and/or water vapor source can be used with warming appliance 10 as an alternative to, or an addition to, external tank 36.

External tank 36 can be in any suitable position with respect to cavity 12 that enables warming appliance 10 to function as described herein. In the exemplary embodiment, external tank 36 is positioned within the cabinet of warming appliance 10, however, external tank 36 can be positioned external to the cabinet using, for example, an external support. In one embodiment, external tank 36 is positioned to enable a user of warming appliance 10 to fill and/or empty external tank 36 by at least partially removing external tank 36 from warming appliance 10 and/or the external support. Alternatively, or additionally, external tank 36 is coupled in fluid communication with a water supply system, such as a residential or commercial water supply system, to be filled directly from the water supply system. Alternatively or additionally, external tank 36 is filled by pouring water into external tank 36 from a water supply not connected to external tank 36, such as a faucet. In a particular embodiment, the fluid in external tank 36 is pre-heated.

Internal reservoir 38 is, in the exemplary embodiment, positioned below rack 32 and above bottom wall 24 such that internal reservoir 38 is within cavity 12. Internal reservoir 38 has any suitable shape and/or dimensions that enables warming appliance 10 to function as described herein. Warming appliance 10 enables water to be held within external tank 36 until the water is evaporated in cavity 12. As such, warming appliance 10 is not required to heat a larger amount of water than needed to provide humidity to cavity 12. For example, in conventional warming appliances, a gallon of water is heated regardless of the desired level of humidity in the cavity. In contrast, warming appliance 10 supplies a relatively small amount of water to internal reservoir 38 for heating, while the remainder of the water is stored in external tank 36. As such, warming appliance 10 consumes less energy than conventional warming appliances and can be pre-heated more quickly than conventional warming appliances. Furthermore, internal reservoir 38 within cavity 12 can be smaller than conventional reservoirs, which enables warming appliance 10 to be more space-effective.

Less energy is used to heat the smaller quantity of water in the smaller internal reservoir 38, and the temperature of the water in the smaller internal reservoir 38 can be changed more quickly than the large amount of water in conventional larger reservoirs. More specifically, when the user desires to change humidity settings and/or revert to a cooking mode, the smaller amount of water enables warming appliance 10 to change settings and/or modes more quickly than conventional warming appliances having large internal water reservoirs. Additionally, fan assembly 26 can be activated to distribute water vapor evenly throughout cavity 12.

External tank 36 is coupled in flow communication with internal reservoir 38 via a feed line 44 and a drain line 46. Feed line 44 is positioned with respect to internal reservoir 38 to enable water to be channeled from feed line 44 into internal reservoir 38. Metering device 40 is positioned along feed line 44 to control a flow of water from external tank 36 to internal reservoir 38, and pump 42 is positioned along drain line 46 to control a flow of water from internal reservoir 38 to external tank 36. Metering device 40 can be any suitable metering device, such as a valve and/or a valve. In the exemplary embodiment, metering device 40 includes a pump (not shown), such as a peristaltic pump, a gear pump, a solenoid pump, and/or a rotary vane pump, that draws fluid from external tank 36 in a substantially precise manner for discharge to internal reservoir 38. Alternatively, when external tank 36 is positioned a height above a height of internal reservoir 38, metering device 40 includes a valve (not shown), such as a solenoid valve, used in conjunction with, for example, a level detector (not shown) within internal reservoir 38. The valve is configured to open when the level detector indicates a low fluid level within internal reservoir 38 and to close when the level detector indicates a high fluid level within internal reservoir 38. Although, a pump and a valve are described above, it should be understood that metering device 40 includes any suitable components that enable humidity control system 34 to function as described herein. In an alternative embodiment, a filter (not shown) is positioned along drain line 46 to filter the water before the water is discharged into external tank 36. The filter is removable for cleaning and/or maintenance.

In the exemplary embodiment, controller 30 is communicatively coupled to metering device 40 and pump 42. More specifically, controller 30 controls a flow rate of water into internal reservoir 38 using metering device 40 and controls a flow rate water from internal reservoir 38 using pump 42. In the exemplary embodiment, controller 30 controls an effective flow rate of water into internal reservoir 38. As used herein, the term “effective flow rate” refers to a plurality of instantaneous flow rates averaged over a time period, for example, a minute. In the exemplary embodiment, metering device 40 discharges water at a flow rate of up to about 473.2 mL (16 oz) per minute (min) for less than 3 seconds (sec) several times a minute to achieve an effective flow rate of less than about 8.8 mL (0.3 oz)/min. In a particular embodiment, controller 30 controls metering device 40 to discharge water into internal reservoir 38 at an effective flow rate of between 5 mL (0.2 oz)/min and about 10 mL (0.3 oz)/min.

Humidity control system 34, in the exemplary embodiment, includes a reservoir heater 48 positioned adjacent a bottom surface of internal reservoir 38 for heating water within internal reservoir 38. Because the water in internal reservoir 38 is heated when cavity 12 is heated by, for example, bake heater 22, reservoir heater 48 is optional and/or selectably controllable.

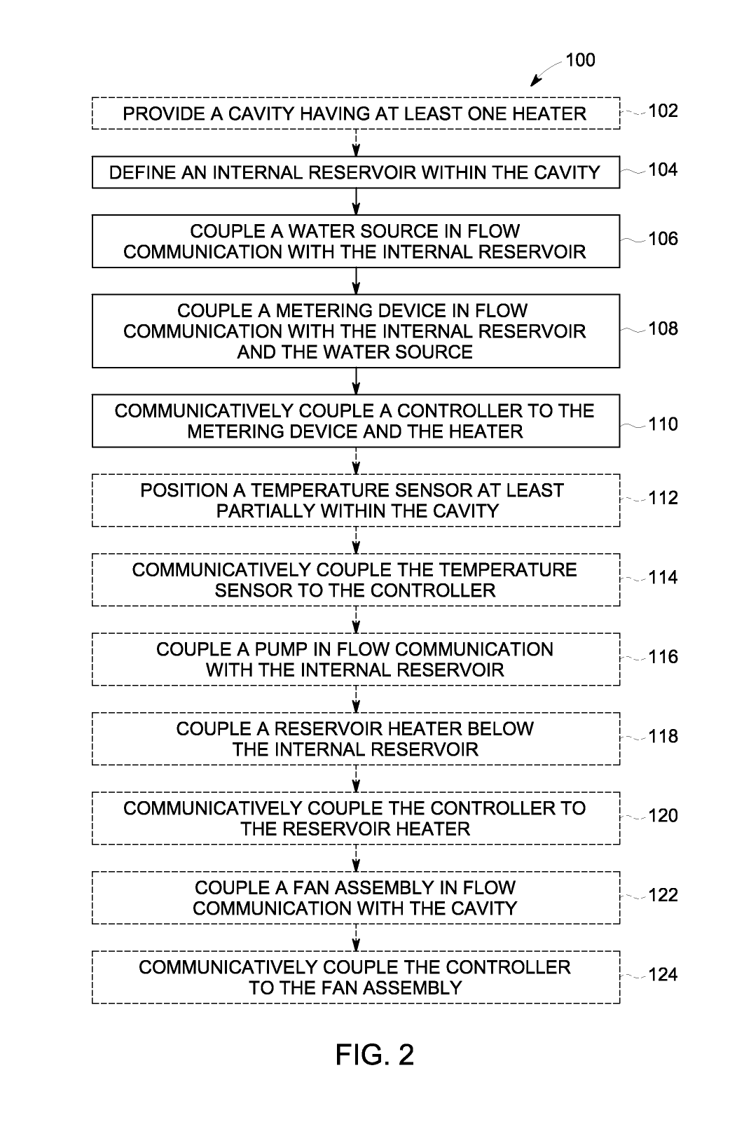

FIG. 2 is a flow chart showing an exemplary method 100 for assembling warming appliance 10 (shown in FIG. 1). Referring to FIGS. 1 and 2, method 100 includes providing 102 cavity 12 having at least one heater 18, 22, and/or 48 and defining 104 internal reservoir 38 within cavity 12. Defining 104 internal reservoir 38 includes coupling internal reservoir 38 within cavity 12 and/or forming internal reservoir 38 integrally within at least one wall 14, 20, and/or 24. A water source external to cavity 12, such as a water supply system and/or external tank 36, is coupled 106 in flow communication with internal reservoir 38. Metering device 40 is coupled 108 in flow communication with internal reservoir 38 and the water source. In the exemplary embodiment, metering device 40 is positioned outside of cavity 12.

Method 100 further includes communicatively coupling 110 controller 30 to metering device 40 and heater 18, 22, and/or 48. Controller 30 is configured to control a flow rate of water from the water source to internal reservoir 38 via metering device 40 and/or a temperature of cavity 12. The flow rate is based on a selected food type to be warmed within cavity 12. Further, controller 30 determines the flow rate, as described in more detail below. Temperature sensor 28 is positioned 112 at least partially within cavity 12, and temperature sensor 28 is communicatively coupled 114 to controller 30. Controller 30 is configured to receive temperature data from temperature sensor 28 to control a temperature and a relative humidity within cavity 12 without using a humidity sensor. Pump 42 is coupled 116 in flow communication with internal reservoir 38. In one embodiment, reservoir heater 48 is coupled 118 below internal reservoir 38, and controller 30 is communicatively coupled 120 to reservoir heater 48 to control a temperature of water within internal reservoir 38. Further, fan assembly 26 is coupled 122 in flow communication with cavity 12, and controller 30 is communicatively coupled 124 to fan assembly 26. Controller 30 is configured to activate fan assembly 26 to circulate water vapor within cavity 12.

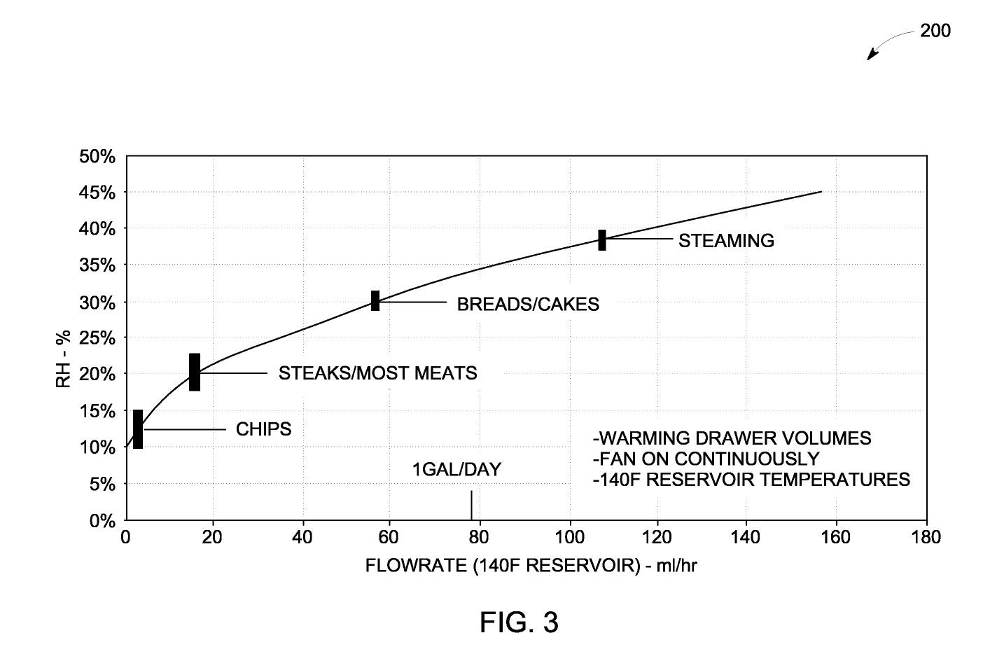

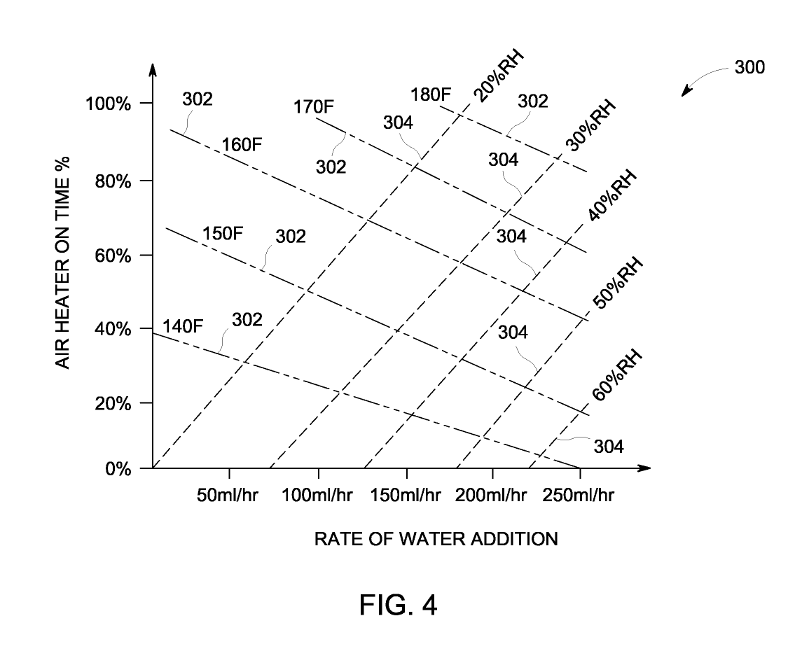

FIG. 3 is a graph 200 illustrating relative humidity with respect to a flow rate when a cavity is at an average temperature of 140 degrees Fahrenheit (° F.). FIG. 4 is a graph 300 illustrating a percentage of time that a heater is activated with respect to an average flow rate of water into an internal reservoir.

Referring to FIGS. 1, 3, and 4, during operation of warming appliance 10, the user positions an item, such as a cooked food item, on rack 32 and closes cavity 12. The user inputs warming information into controller 30 via user interface 31. More specifically, in the exemplary embodiment, the user inputs a temperature, such as a temperature between about 140° F. and 160° F., that will maintain a temperature of the cooked food until serving. When the user desires humidity control within cavity 12, the user inputs a type of food item and/or a desired relative humidity into controller 30. In a particular embodiment, the user interface allows the user to select predetermined settings, such as “Crispy,” “Meats,” “Bread,” or “Steaming.” The user fills external tank 36 with water prior to starting a warming process either by pouring water into external tank 36 or using a water supply in flow communication with external tank 36.

As shown in graph 200 in FIG. 3, the Crispy setting is at about 12% RH, the Meat setting is at about 20% RH, the Bread setting is at about 30% RH, and the Steaming setting is at about 37% RH. Further, as shown in graph 200, each humidity setting corresponds to a different flow rate of water into internal reservoir 38. Using graph 200, controller 30 determines a level of relative humidity and a temperature based at least on the type of food item selected by the user. Stated differently, controller 30 determines a level of relative humidity and a temperature for cavity 12 based at least on a signal output by, and received from, user interface 31. The signal represents or indicates at least a type of food and/or a cavity temperature.

Controller 30 then determines a flow rate of water from external tank 36 to internal reservoir 38 to achieve and/or maintain the determined relative humidity and/or temperature for the selected type of food. Alternatively, the user selects the type of food and the temperature, and controller 30 determines a flow rate to maintain the determined relative humidity. In the exemplary embodiment, controller 30 uses correspondences of relative humidity at a particular flow rate for a given temperature in cavity 12. The temperature within cavity 12 is determined using temperature data from temperature sensor 28. Temperature/humidity/flow rate correspondences are illustrated in a graph 300 shown in FIG. 4. More specifically, FIG. 3 shows graph 300 of a percentage of time that at least bake heater 22 and/or reservoir heater 48 is activated with respect to an average flow rate of water into internal reservoir 38. Dotted lines 302 show average temperatures attained by the percentage of time that air is heated, and dashed lines 304 show average relative humidity attained by the flow rate of water.

By using graph 300, controller 30 determines for what percentage of time to activate at least bake heater 22 and/or reservoir heater 48 and at what flow rate to channel water into internal reservoir 38 to achieve the selected temperature and relative humidity within cavity 12. In the exemplary embodiment, graph 300 is determined empirically; however, relationships among temperature, relative humidity, and flow rate can be determined using any suitable method that enables warming appliance to function as described herein. More specifically, controller 30 uses characteristics of metering device 40 and/or feed line 44 and/or graph 200 to determine a flow rate and/or a quantity of water supplied to internal reservoir 38 from external tank 36, as described in more detail above. Alternatively, controller 30 uses any suitable parameters and/or sensors to determine a flow rate of water to internal reservoir 38 and/or an amount of water discharged from external tank 36.

After determining what percentage of time to activate at least bake heater 22 and/or at what flow rate to channel water into internal reservoir 38, controller 30 controls metering device 40 to meter water from external tank 36 to internal reservoir 38 via feed line 44. In the exemplary embodiment, controller 30 determines the relative humidity within cavity 12 as described above without the use of a humidity sensor within cavity 12. Controller 30 can activate reservoir heater 48 to facilitate achieving and/or maintaining the relative humidity within cavity 12 by controlling an evaporation rate of the water. To substantially uniformly distribute water vapor within cavity 12, controller 30 activates fan assembly 26 to circulate the water vapor.

When warming is ended, the water is channeled from internal reservoir 38 to external tank 36 using drain line 46. More specifically, controller 30 activates pump 42 to channel water from internal reservoir 38 to external tank 36 through drain line 46. When the filter is included, the water is filtered before being discharged into external tank 36. In the exemplary embodiment, controller 30 is configured to allow the user to select to drain internal reservoir 38 and/or controller 30 automatically drains internal reservoir 38 after deactivation of warming appliance 10. In an alternative embodiment, water is drained from internal reservoir 38 to any suitable location, such as a residential or commercial plumbing system. As such, in the exemplary embodiment, warming appliance 10 enables internal reservoir 38 to be drained and the water to be re-captured by using pump 42 that is automatically or manually activated. External tank 36 is easily accessible to the user to re-fill the external tank and/or to remove re-captured water from external tank 36. Even if internal reservoir 38 is not drained, the smaller size of internal reservoir 38 having a smaller amount of water enables the remaining water to evaporate as warming appliance 10 cools within a reasonably short amount of time. Any remaining food residue can be wiped out of cavity 12.

As an alternative to the above-described embodiment, steam can be channeled into cavity 12 from an external steam source. As such, water vapor is supplied directly to cavity 12. By metering the steam flow, a selected relative humidity can be achieved and/or maintained within cavity 12.

The above-described embodiments provide a warming appliance that maintains humidity control at given temperatures with a minimum of control devices, such as a metering device, an external water supply, and an internal water holding reservoir. More specifically, water from an external tank is metered to the internal reservoir via the metering device to achieve and/or maintain a selected relative humidity within the cavity. The flow rate and/or amount of water to supply to the internal reservoir is determined based on a temperature within the cavity and the selected humidity level. As such, a user can select a humidity level based on, for example, the type of food to keep warm within the warming appliance, and the warming appliance automatically maintains the relative humidity and temperature in the cavity without monitoring by the user. Moreover, the user interface described herein enables the user to easily select a food type to be warmed, as compared to warming appliances having complicated wet bulb/dry bulb controls.

Further, the accessibility of the external tank and/or the draining feature enable the user to more easily clean and/or maintain the warming appliance, as compared to warming appliances having a large internal reservoir that may need daily cleaning. Additionally, the drain and pump from the internal reservoir enables a humidity level within the warming appliance to be adjusted from a higher humidity level to a lower humidity level by removing water from the internal reservoir. As such, the humidity level can be lower without waiting for extra water within the cavity to evaporate.

A technical effect of the systems and method described herein includes at least one of: (a) receiving an input of a selected food type and a selected temperature within a cavity; (b) determining a flow rate of water into an internal reservoir to achieve a humidity within a cavity based on a selected food type and a selected temperature within the cavity; and (c) controlling a flow rate of water from an external tank to an internal reservoir based on a determined humidity and a temperature within the warming cavity.

Exemplary embodiments of a humidity control system for use with a warming appliance and method for manufacturing the same are described above in detail. The systems and method are not limited to the specific embodiments described herein, but rather, components of systems and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A humidity control system for use with a warming appliance including a warming cavity, said humidity control system comprising:
an internal reservoir for retaining water within the warming cavity;
a metering device;
a water source external to the warming cavity and coupled in flow communication with said internal reservoir via said metering device; and
a controller communicatively coupled to said metering device, said controller configured to control a flow rate of the water from said water source to said internal reservoir based on a selected food type being warmed within the warming cavity.

2. A humidity control system in accordance with claim 1, wherein said controller controls the flow rate of the water by metering a flow of the water using said metering device.

3. A humidity control system in accordance with claim 1, further comprising:
a drain line coupled in flow communication with said internal reservoir; and
a pump coupled to said drain line, said pump configured to remove the water from said internal reservoir via said drain line.

4. A humidity control system in accordance with claim 3, wherein said controller activates said pump to remove the water from said internal reservoir.

5. A humidity control system in accordance with claim 1, wherein said internal reservoir has a capacity of less than about 16 ounces.

6. A humidity control system in accordance with claim 1, further comprising a fan assembly, said controller configured to activate said fan assembly to circulate water vapor within the warming cavity.

7. A humidity control system in accordance with claim 1, wherein said water supply comprises an external tank for retaining water outside of the warming cavity, said external tank in flow communication with said internal reservoir via said metering device.

8. A warming appliance, comprising:
walls at least partially defining a warming cavity for containing an item to be warmed; and
a humidity control system comprising:
an internal reservoir configured to retain water within said warming cavity;
a metering device;
a water source external to said warming cavity and coupled in flow communication with said internal reservoir via said metering device; and
a controller communicatively coupled to said metering device, said controller configured to control a flow rate of the water from said water source to said internal reservoir based on a selected food type to be warmed within said warming cavity.

9. A warming appliance in accordance with claim 8, further comprising a temperature sensor within said warming cavity, said controller is configured to control a temperature and a relative humidity within said warming cavity based on temperature data output by and received from said temperature sensor.

10. A warming appliance in accordance with claim 8, wherein said water supply comprises an external tank for retaining water outside of said cavity, said external tank in flow communication with said internal reservoir via said metering device.

11. A warming appliance in accordance with claim 10, wherein said humidity control system further comprises:
a drain line coupled in flow communication with said internal reservoir and said external tank; and
a pump positioned along said drain line, said pump configured to remove the water from said internal reservoir to said external tank via said drain line.

12. A warming appliance in accordance with claim 8, further comprising a reservoir heater positioned adjacent said internal reservoir, said controller configured to activate said reservoir heater to control a relative humidity within said warming cavity.

13. A warming appliance in accordance with claim 8, further comprising a fan assembly, said controller configured to activate said fan assembly to circulate water vapor within said warming cavity.

14. A warming appliance in accordance with claim 8 comprising at least one of a warming drawer and an oven.

15. A method for assembling a warming appliance including a cavity having at least one heater, said method comprising:
defining an internal reservoir within the cavity;
coupling a water source external to the cavity in flow communication with the internal reservoir;
coupling a metering device in flow communication with the internal reservoir and the water source;
communicatively coupling a controller to the metering device and the at least one heater, the controller configured to control a flow rate of water from the water source to the internal reservoir via the metering device, wherein the flow rate is based on a selected food type to be warmed within the cavity.

16. A method in accordance with claim 15, wherein coupling a metering device in flow communication with the internal reservoir and the water source further comprises positioning the metering device outside of the cavity.

17. A method in accordance with claim 15 further comprising:
positioning a temperature sensor at least partially within the cavity; and
communicatively coupling the temperature sensor to the controller, the controller configured to receive temperature data from the temperature sensor to control a temperature and a relative humidity within the cavity without using a humidity sensor.

18. A method in accordance with claim 15 further comprising coupling a pump in flow communication with the internal reservoir, the pump configured to channel water from the internal reservoir to drain the internal reservoir.

19. A method in accordance with claim 15 further comprising:
coupling a reservoir heater below the internal reservoir; and
communicatively coupling the controller to the reservoir heater to control a temperature of water within the internal reservoir.

20. A method in accordance with claim 15 further comprising:
coupling a fan assembly in flow communication with the cavity; and
communicatively coupling the controller to the fan assembly, the controller configured to activate the fan assembly to circulate water vapor within the cavity.
